(19) United States
(12) Patent Application Publication
(10) Pub. No.: US 2024/0219995 A1
(43) Pub. Date: Jul. 4, 2024

(54) CHARGE ISOLATION ARCHITECTURE IN VOLTAGE REGULATOR FOR IMPROVED BATTERY LIFE, RESPONSIVENESS AND REDUCED ACOUSTIC NOISE

(71) Applicants: Wei Chang Tan, Bayan Lepas (MY); Chuen Ming Tan, Bayan Lepas (MY); Philip R. Lehwalder, Hillsboro, OR (US); Patrick K. Leung, Portland, OR (US)

(72) Inventors: Wei Chang Tan, Bayan Lepas (MY); Chuen Ming Tan, Bayan Lepas (MY); Philip R. Lehwalder, Hillsboro, OR (US); Patrick K. Leung, Portland, OR (US)

(21) Appl. No.: 18/091,207

(22) Filed: Dec. 29, 2022

(51) Int. Cl. G06F 1/3296; G05F 1/575

(52) U.S. Cl. CPC G06F 1/3296; G05F 1/575

(57) ABSTRACT

Embodiments herein relate to a voltage regulator (VR) circuit which reduces power consumption and latency when an associated system on a chip (SoC) or other processor transitions between active and idle states. The circuit includes bulk capacitors coupled to a power output rail of the VR, and switches which isolate the capacitors when the SoC is in the idle state. The capacitors maintain their charge so they do not have to be charged up in an idle to active state transition. In this transition, the voltage on the output power rail can be monitored and the switches can be turned on to remove the isolation when the voltage reaches a threshold level. A VR controller can subsequently provide a power good signal to the SoC to allow it to begin performing operations in the active state.

### FIELD

The present application generally relates to the field of computing devices and more particularly to voltage regulator (VR) circuit which supplies power to an integrated circuit such as a processor in a system on a chip.

### BACKGROUND

A VR is used in a computing system to supply power to processors and other circuits of the system. A VR can provide power at different voltages such as 3.3 V, 5 V and 12 V, for use by various components in the computing system. However, various challenges are presented in reducing the power consumption of a VR.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1A depicts a computing system 100 which includes a system on a chip (SoC) 101, a voltage regulator (VR) controller 102, and a VR 103, according to various embodiments.

FIG. 1B depicts a plot 110 of a voltage output of a VR versus time and a plot 120 of a voltage identification (VID) signal versus time, consistent with the computing system of FIG. 1A, according to various embodiments.

FIG. 2 depicts a plot of inrush power of a capacitor in a VR versus a wake cycle period of a SoC, according to various embodiments.

FIG. 3 depicts a real-world wake time distribution of a SoC, including a residency and an accumulated distribution versus a wake cycle period, according to various embodiments.

FIG. 4 depicts an example circuit 400 which includes a VR 410 having bulk capacitors C1, C2 and C3 and respective switches S1, S2 and S3 such as n-type transistors in respective paths P1, P2 and P3, and an associated VR controller 430, according to various embodiments.

FIG. 5 depicts an example circuit 500 which includes a VR 510 having bulk capacitors C1, C2 and C3 and a common switch S2 (such as an n-type transistor) in respective paths P1a, P2a and P3a, and the associated VR controller 430, according to various embodiments.

FIG. 6 depicts an example circuit 600 which includes a VR 610 having bulk capacitors C1, C2 and C3 and respective switches Sla, S2a and S3a (such as p-type transistors) in respective paths P1b, P2b and P3b, and the associated VR controller 430, according to various embodiments.

FIG. 7 depicts example waveforms for use in the circuits 400, 500 and 600 of FIGS. 4, 5 and 6, respectively, according to various embodiments.

FIG. 8A depicts a flowchart of an example process in which a SoC transitions from an active state to an idle state, according to various embodiments.

FIG. 8B depicts a flowchart of an example process in which a SoC transitions from an idle state to an active state, according to various embodiments.

FIG. 9 depicts an example plot of a voltage output of a VR versus time, in a discussion of energy savings per wake cycle period, according to various embodiments.

FIG. 10 depicts an example circuit in a VR including an inductor L, an equivalent series resistance (ESR_bulk_cap) of a bulk capacitor, and a capacitance (C_bulk) of the bulk capacitance, in a discussion of energy savings per wake cycle period, according to various embodiments.

FIG. 11 depicts an example energy consumption equation for a wake cycle period such as depicted in FIG. 9, according to various embodiments.

FIG. 12 depicts an example SoC leakage current model, according to various embodiments.

FIG. 13 depicts an example plot of SoC leakage current versus Voutput, according to various embodiments.

FIG. 14 depicts an example plot of energy saved in a wake cycle period as a function of t_off (a VR off time), according to various embodiments.

FIG. 15 depicts an example bar chart of power saved as a function of wake cycle period and a plot 1500 of accumulated power saved as a function of wake cycle period, according to various embodiments.

FIG. 16 illustrates an example of components that may be present in a computing system 1050 for implementing the techniques (e.g., operations, processes, methods, and methodologies) described herein, according to various embodiments.

### DETAILED DESCRIPTION

As mentioned at the outset, various challenges are presented in reducing the power consumption of a VR.

One approach to reduce power consumption in a computing system is to provide different power states for a processor, which may be in a system on a chip (SoC), for example. When the processor is not performing tasks, it can transition to a lower power state, such as an idle or sleep state, in which it draws little or no power from a VR. However, when the processor transitions between active and idle states, this results in the repeated charging and discharging of bulk capacitors in the VR. The bulk capacitors are used to stabilize an output voltage of the VR. A VR may also include decoupling capacitors to decouple the load and suppress high-frequency noise. However, the bulk capacitors have a much larger capacitance than the decoupling capacitors.

One disadvantage of the repeated charging and discharging of bulk capacitors is reduced efficiency. Each time an SoC enters the idle state, energy in the bulk capacitors is lost due to SoC leakage current. As a result, the VR must use additional energy to charge the bulk capacitors back to their original voltage when the SoC subsequently exits the idle state and enters the active state. Moreover, the problem is worse when the platform has a high amount of capacitance and when the SoC leakage is high.

Another disadvantage is reduced workload responsiveness. It takes time to charge the bulk capacitors from 0 V to a nominal target voltage when the SoC transitions from the idle state to the awake state, and the SoC cannot start any workload/computational tasks until the power output rail of the VR reaches the target voltage. This problem is worsened when larger capacitors are used since the inrush current is larger, and this limits the rate of which the capacitors can be charged. This introduces a latency that can affect the responsiveness of applications or other programs running on the SoC.

A further disadvantage is capacitor acoustic noise such as when ceramic capacitors are used. If the SoC idle entry/exit occurs with a frequency in the audio frequency range, it can cause acoustic noise as the capacitors vibrate in the audio frequency range due to the change in voltage on the capacitors. One possible solution is to limit the frequency of the idle entry/exit. However, this can prevent the SoC from going to idle in some cases so that power consumption is not optimized.

A solution provided herein addresses the above and other issues. The solution aims to resolve all the problems mentioned above by isolating any charge in the bulk capacitor, thus significantly increasing the efficiency of SoC idle entry and exit. Any bulk capacitor charge is conserved and reused for the next SoC idle exit rather than allowing the capacitor charge to dissipate due to the SoC leakage current. This solution also significantly improves SoC idle exit voltage ramp up time, thus reducing latency of the SoC.

In one aspect, one or more bulk capacitors of a VR are provided in a switched path which includes a switch such as a transistor, e.g., a metal-oxide-semiconductor field-effect transistor (MOSFET). The switches can be controlled by a signal from a VR controller based on the active/idle state of the processor. When a processor enters the idle state, the VR controller provides a voltage identifier (VID) command to the VR to instruct the VR to output 0 V. For a switching VR, the VR stops switching. At this time, the VR controller also turns off the switches to isolate the charge on the bulk capacitors, thus preventing any loss of energy on the bulk capacitors due to SoC leakage. In particular, the VR controller turns off the switches to prevent the bulk capacitors from discharging. For example, in each switched path, the switch may be between the bulk capacitor and ground. When the switch is turned off, the voltage on the ground-facing side of the capacitor floats. The opposite side of the capacitor continues to be coupled to the power output rail of the VR which also has a floating voltage so that the voltage across the bulk capacitor is maintained.

When the processor subsequently exits the idle state and transitions back to the active state, the VR controller instructs the VR to begin switching again to output a nominal voltage. Additionally, the VR turns on the switches to end the isolation of the bulk capacitors. During this transition, the VR controller may monitor the voltage of the power output rail and delay turning on the switches until the voltage is sufficiently high, e.g., within a margin of a nominal target voltage. The VR controller may then assert a power good signal which informs the processor that it can resume the active state.

The solution can be implemented with only minor changes to existing VR controllers.

A number of advantages can be achieved. For example, battery life can be improved in the computing system, such as a laptop or other portable computing device. The architecture also allows capacitor charge energy to be conserved and reused in subsequent idle to active transitions of a processor, so that each idle entry and exit will be more efficient. The capacitor isolation also allows faster entry and exit through the reduced inrush current. Another advantage is improved responsiveness/reduced exit latency. The isolation of the bulk capacitors means the VR does not need to charge the bulk capacitors from the discharged state when the processor exits the idle state, thus decreasing the delay before the SoC can start its processing/workload. The VR may perform a brief charging of the bulk capacitors to restore charge which is lost through minor leaks through the switch. In particular, it is expected that the voltage ramp up time of the VR can be reduced to one-half or one-third of its nominal time. A further advantage is acoustic noise reduction. Since this architecture isolates the bulk capacitors to maintain the charge, the capacitors do not undergo a charge/discharge cycle, thereby reducing acoustic noise issues such as when ceramic capacitors are used. The techniques are applicable to any type of circuit which is powered by a VR and which transitions between active and idle states.

The above and other advantages will be further apparent in view of the following discussion.

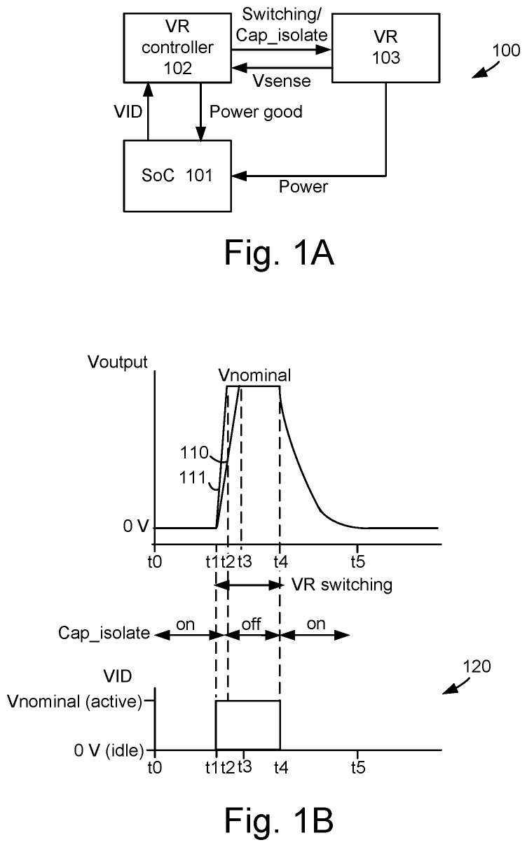

FIG. 1A depicts a computing system 100 which includes a system on a chip (SoC) 101, a voltage regulator (VR) controller 102, and a VR 103, according to various embodiments. A system on a chip is an integrated circuit that integrates most or all components of a computer or other electronic system on a single chip. A SoC includes a processor such as a central processing unit (CPU) and may also include system memory, peripheral controllers and more advanced peripherals such as graphics processing units (GPUS), specialized neural network circuitry, radio modems (e.g., for Bluetooth or Wi-Fi), and more./

The SoC receives power from the VR 103, which is under the control of the VR controller 102. The VR may be a switching regulator, for example, with high and low power transistors which are alternately turned on and off. In one possible implementation, the VR is a buck converter, or step-down converter, which is a DC-to-DC power converter which steps down voltage (while stepping up current) from its input (supply) to its output (load). Other examples of switching regulators include a boost, or step-up regulator and a buck/boost (step-down/up) switching regulator. Other types of VRs may be used as well such as a linear voltage regulator.

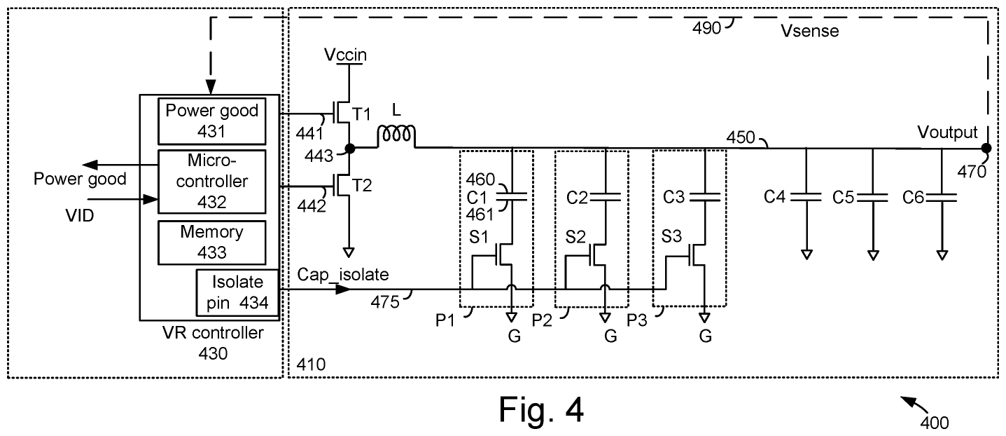

The VR controller may provide switching signals to the high and low power transistors, for example, with a specified duty cycle to achieve a target output voltage. With the solutions provided herein, the VR controller may further provide a capacitor isolation signal, Cap_isolate, to the VR. The isolation signal is asserted during an idle state of the SoC to isolate the bulk capacitors of the VR (see FIG. 4-6) so that they are not discharged via the power output rail of the VR due to current leakage in the SoC. The SoC communicates to the VR controller on the VID signal or power state which indicates whether it is in an active or idle state. The communication can be over any sort of communication bus such as Inter-Integrated Circuit (I2C), Improved Inter Integrated Circuit (13C) or Serial Peripheral Interface (SPI). The VR controller may also provide a power good signal to the SoC which informs the SoC that the output power of the VR is at a target level so that the SoC can resume its processing in the active state. To provide this signal, the VR controller may sense a voltage, Vsense, on the power output rail of the VR. The power good signal can also inform a motherboard that the voltage output is within specifications.

The active or idle state of the SoC may refer to the active or idle state of one or more processors of the SoC, in one approach. If the SoC has multiple processors, the SoC may be in the active state if any of its processors is in the active state, and the SoC may be in the idle state if each of its processors is in the idle state. The active state of a processor can refer to its normal operating state where it performs various operations. In some cases, an active state is referred to as a P state. A processor can have different P states which correspond to different voltage and/or frequency levels. For example, P0 may be the highest state resulting in maximum performance, while P1, P2, and so on, will save power but at some penalty to CPU performance. The idle state of a processor may refer to a state in which it does not perform operations. In some cases, the idle state is referred to as a C6 or C8 state, and is the most powered down state, sometimes referred to as a deep powered down state. In this state, the local caches (level 1 and 2 or L1/L2 caches) of the core are flushed and the core is powered down. When all the cores are powered down, the shared cache (level 3 or L3, or last level cache or LLC) of the package is flushed. The package is almost fully powered down, as some power is needed to power back on to the active state.

FIG. 1B depicts a plot 110 of a voltage output of a VR versus time and a plot 120 of a voltage identification (VID) signal versus time, consistent with the computing system of FIG. 1A, according to various embodiments. Time points t0-t5 are depicted.

From t0 to t1, SoC is in an idle state. In a comparative case, plot 110 shows that the Voutput, the VR output voltage, is 0 V when the SoC is in the idle state. At t1, the VID is set to Vnominal, indicating the SoC desires to enter the active state. For example, the VID may transition from requesting 0 V to requesting Vnominal. However, the SoC cannot begin performing operations in the active state until Voutput has increased to the nominal level, Vnominal. This ramp up of Voutput takes time due to the charging of the relatively large bulk capacitors which cause a large inrush current. The VR begins switching at t1 so that the output increases to Vnominal at t3. A short time after t3, power good is set to inform the SoC that the Voutput is at the specified level, Vnominal, so the SoC cannot begin performing operations.

In a case which uses the solutions described herein, the ramp up of Voutput of plot 111 is faster, occurring from t1 to t2, so that power good is set sooner. The time savings is t3-t2. Cap_isolate is also used in this case. Cap_isolate is set to on when the SoC is in the idle state, from t0 to t2 and t4 to t5. Cap_isolate is set to off from t2 to t4, indicating the isolation of the capacitors ends. Generally, in an idle active state transition, the isolation can end when Voutput is at or close to Vnominal.

At t4, the SoC decides to enter the idle state. It sends a 0 V VID command to the VR controller and stops any workload. The VR switching stops and power good is set to off. The voltage across the capacitors starts to decay due to SoC leakage current, so that the Voutput gradually decays to as low as 0 V, for example, at t5.

Note that the SoC can request different levels of Voutput based on its performance needs. A higher Voutput can be requested when higher performance is needed. One example technique which can be used is the Intel® Mobile Voltage Positioning standard and architecture which allows the SoC to dynamically change the voltage. In the SoC idle or active states, the SoC will put the IMVP VR in a VID=0 V or ID=Vnominal mode, respectively. Voutput can be fixed or varying within an active period and/or in different active periods. An SoC may transition between the active and idle states many times per second.

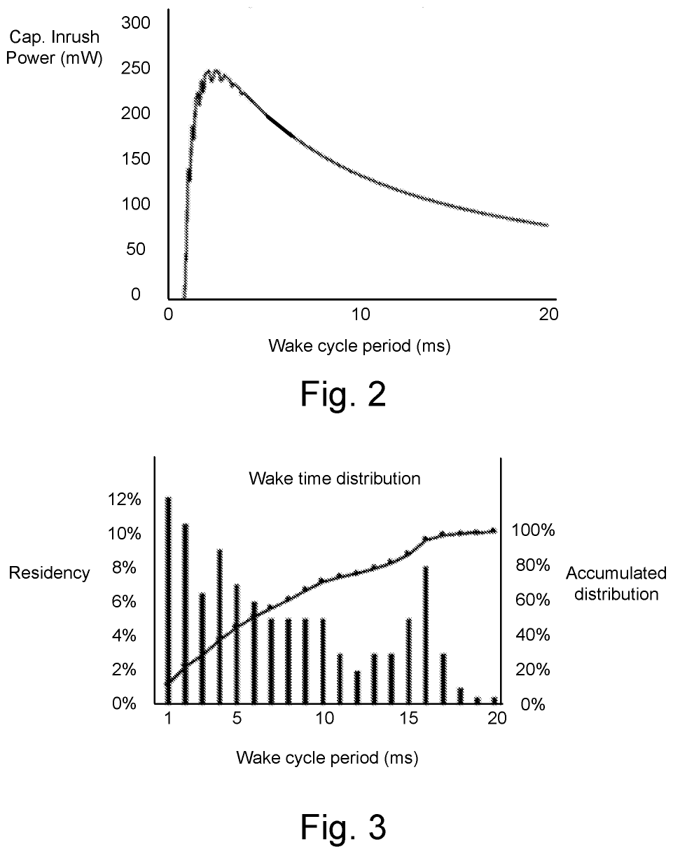

FIG. 2 depicts a plot of inrush power of a capacitor in a VR versus a wake cycle period of a SoC, according to various embodiments. The data represents real-world usage of a personal computer. The wake cycle period is the time between two consecutive idle to active state transitions. A large portion of the residency time is 1-5 ms. Generally, as the capacitance and SoC leakage change, the capacitor inrush power will change.

FIG. 3 depicts a real-world wake time distribution of a SoC, including a residency and an accumulated distribution versus a wake cycle period, according to various embodiments. The bar chart denote residency, which is a percentage of samples having the specified wake cycle period, and the increasing plot denotes an accumulated distribution, which is a sum of the residencies over the samples. The residency tends to be larger for shorter wake times, although there is a secondary peak at 16 ms. This shows that transitions between the idle and active states occur very frequently so that a power savings in such transitions can add up quickly over time. Data also indicates that charging the bulk capacitors of a VR in each idle to active state transition can consume over 150 mW.

FIG. 4 depicts an example circuit 400 which includes a VR 410 having bulk capacitors C1, C2 and C3 and respective switches S1, S2 and S3 such as n-type transistors in respective paths P1, P2 and P3, and an associated VR controller 430, according to various embodiments. The VR controller includes a microcontroller 432 or other controller or circuit which is to execute instructions stored in a memory 433. The microcontroller may receive the VID signal. A power good block 431 represents logic which is implemented by the microcontroller to decide whether to assert the power good signal for the SoC or other processor which is powered by the VR. An isolate pin 434 is a pin used to send the Cap_isolate signal to one or more bulk capacitors of the VR.

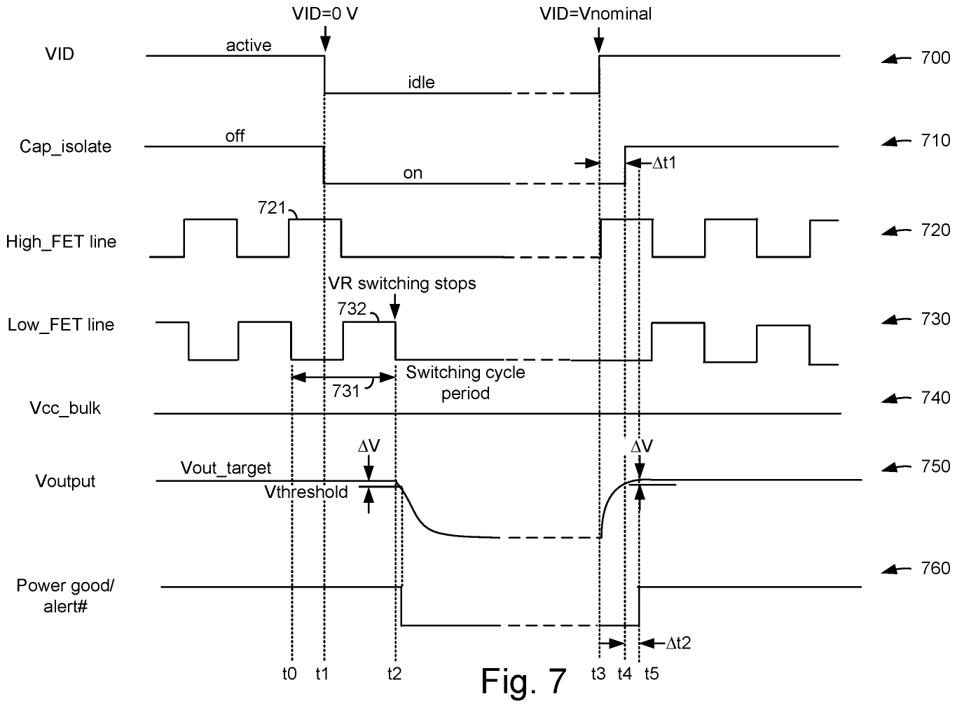

The VR controller provides switching signals to control gates of a high side power transistor T1 and a low side power transistor T2 via paths 441 and 442, respectively. The signals are alternately high and low according to a duty cycle which determines the output voltage Voutput on the power output rail 450. See also FIG. 7, where path 441 is the High_FET line and path 442 is the Low_FET line. A voltage is output to the power output rail at a point 443 between the power transistors. An inductor L is coupled at one side to the point 443 and at the opposite side to the power output rail. The inductor is an energy storage element which smooths out the output voltage. Generally, a set of one or more bulk capacitors can be coupled to the power output rail. In this example, three bulk capacitors C1, C2 and C3 are coupled to the power output rail in paths P1, P2 and P3, respectively. Each path is a switched path which includes a switch such as a transistor, e.g., an n-type MOSFET. Each switched path extends from the power output rail to a ground node (G). In this example, each bulk capacitor is between the power output rail and ground, and each switch comprises an n-type transistor between the capacitor and ground.

Each of the switches S1-S3 receives the common Cap_isolate signal from the isolate pin 434 of the VR controller on a path 475. The path 475 may be coupled to control gates of the switches S1-S3. When the switches are n-MOSFETs, a high level of Cap_isolate will turn the switches on and a low or 0 V level of isolate will turn the switches off. For example, when the switch S1 is turned on (made conductive from its drain to its source), one side 461 of the capacitor C1 is electrically connected to ground. As a result, the capacitor C1 is not isolated from, and can be charged by or discharge into, the power output rail since the bias across the capacitor can be non-zero. When the switch S1 is turned off (made non-conductive from its drain to its source), the one side 461 of the capacitor is no longer electrically connected to ground so that its voltage floats. As a result, the capacitor C1 is isolated from, e.g., not charged by and does not discharge into, the power output rail since the bias across the capacitor is essentially 0 V. The side 460 of C1 which faces the power output rail may be electrically connected to the power output rail when S1 is on or off. The other switches S2 and S3 and capacitors C2 and C3 can operate similarly.

The VR may further include decoupling capacitors C4, C5 and C6 to decouple the load from the voltage regulator such as by suppressing high-frequency noise. The decoupling capacitors can filter out voltage spikes and pass through only the DC component of Voutput. The load is coupled to the output voltage, Voutput, at the output node 470 of the power output rail 450. As mentioned, the capacitance of the decoupling capacitors is many times, e.g., ten times or more, smaller than the capacitance of the bulk capacitors, so that charging of these capacitors consumes relatively little energy. Generally, one or more decoupling capacitors may be provided.

The VR controller may monitor the voltage at the output node 470 as a sense voltage, Vsense, on a feedback path 490. The VR controller can adjust the duty cycle of the signals on the paths 441 and 442 based on Vsense. If Vsense is less than a target voltage, the duty cycle can be increased. If Vsense is greater than a target voltage, the duty cycle can be decreased. Vsense can also be used to determine when to assert the power good signal after an idle to active state transition. When Vsense exceeds a threshold level, the power good signal can be asserted to inform the SoC that it is safe to begin operations.

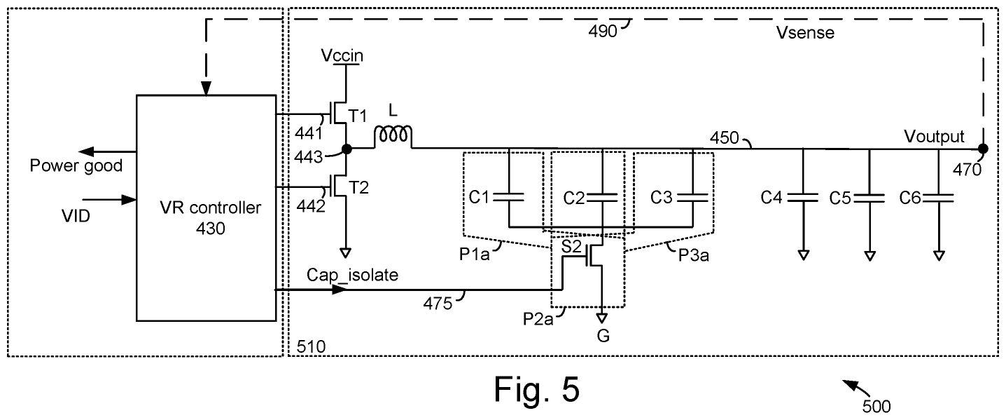

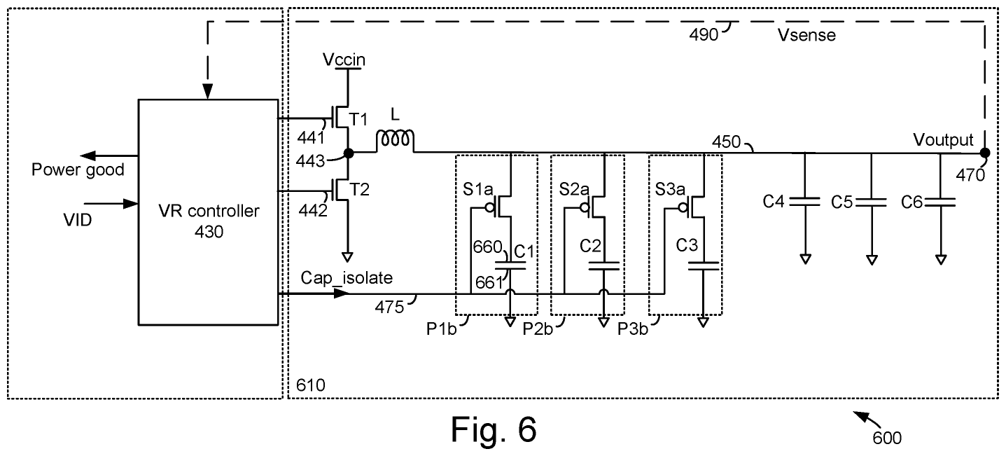

The example circuit 400 uses the charge isolation architecture. The isolate pin 434 can be added to the VR controller to control the bulk capacitors. To reduce inrush current during charge redistribution when the bulk capacitors are connected back to the power output rail in an idle to active transition of the SoC, a slew rate limiting feature can be added. The switches can be MOSFETs which are used to isolate the bulk capacitors from Voutput on the power output rail. These MOSFETs can be configured as low side switches, such as shown in FIGS. 4 and 5, or high side switches such as shown in FIG. 6. Note that the MOSFETs can be external to the VR controller and SoC as shown in FIG. 4-6, in one possible approach. In another approach, the MOSFETs can be built into the SoC or VR controller to take advantage of the smaller process node, lower voltage and reduced die size. The VR controller 430 supports the charge isolation architecture and can be an IMVP controller, in one example implementation.

FIG. 5 depicts an example circuit 500 which includes a VR 510 having bulk capacitors C1, C2 and C3 and a common switch S2 such as an n-type transistor in respective paths P1a, P2a and P3a, and the associated VR controller 430, according to various embodiments. In this example, there is one switch for multiple bulk capacitors.

Generally, various options are possible. For example, each switch S1-S3 could receive a separate Cap_isolate signal. The capacitors C1, C2 and C3 can have a same or different capacitance and be of the same or different type. In one approach, the capacitors are made of ceramic. A ceramic capacitor can comprise two or more alternating layers of ceramic material as the dielectric, and metal layers acting as the non-polarized electrodes.

The bulk capacitors C1, C2 and C3 are coupled to the power output rail in paths P1a, P2a and P3a, respectively, where the paths are overlapping from S2 to the ground point G. The switch S2 comprises an n-type transistor between the capacitors and ground.

The switch S2 receives a Cap_isolate signal from the VR controller on a path 475, which may be coupled to the control gate of the switch S2. When the switch S2 is turned on or off, the power output rail-facing side of each capacitor C1-C3 is electrically connected to the power output rail 450. When S2 is turned on, an opposing, ground-facing side of each capacitor is grounded. As a result, the capacitors C1-C3 are not isolated from, and can be charged by or discharge into, the power output rail. When the switch S2 is turned off, the ground-facing side of each capacitor is electrically disconnected from ground so that its voltage is floated. As a result, the capacitors C1-C3 are isolated from, e.g., not charged by and do not discharge into, the power output rail.

FIG. 6 depicts an example circuit 600 which includes a VR 610 having bulk capacitors C1, C2 and C3 and respective switches Sla, S2a and S3a such as p-type transistors in respective paths P1b, P2b and P3b, and the associated VR controller 430, according to various embodiments. In this example, the switches S1, S2 and S3 are p-MOSFETs which are located between the power output rail 450 and the capacitors C1, C2 and C3, respectively.

In this example, the switches Sla, S2a and S3a are coupled to the power output rail in paths P1b, Pb2 and P3b, respectively. Each path is a switched path which includes a p-type switch such as a p-type MOSFET. In this example, each bulk capacitor is between the associated switch and ground. Also, each switch comprises a p-type transistor between the capacitor and the power output rail.

Each of the switches S1a-S3a receives a common isolate signal, Cap_isolate, from the VR controller on the path 475, which may be coupled to control gates of the switches S1a-S3a. When the switches are p-MOSFETs, a high level of Cap_isolate will turn the switches off and a low or 0 V level of Cap_isolate will turn the switches on. For example, when the switch Sla is turned on, one side 660 of the capacitor C1 is electrically connected to the power output rail 450. As a result, the capacitor C1 is not isolated from, and can be charged by or discharge into, the power output rail. When the switch Sla is turned off, the one side 660 of the capacitor is electrically disconnected from the power output rail so that its voltage floats. The opposing side 661 of the capacitor is connected to ground in either case so it is at 0 V, in one approach. The side 660 of C1 faces the switch Sla and the power output rail and the side 661 faces the ground point. The other switches S2 and S3 and capacitors C2 and C3 can operate similarly.

FIG. 7 depicts example waveforms for use in the circuits 400, 500 and 600 of FIGS. 4, 5 and 6, respectively, according to various embodiments. The waveforms represent an idle entry and idle exit sequence that can be implemented by the VR controller.

The waveform 700 depicts the VID signal from the SoC. In one approach, this VID command is interpreted by the VR controller as an active/idle signal. For example, when VID=Vnominal, the SoC is assumed to be in the active state and when VID=0 V, the SoC is assumed to be in the idle state. In another approach, the SoC provides an active/idle signal which is separate from the VID command. Here, when VID transitions from requesting an output of Vnominal to requesting an output of 0 V at t1, this means there is a transition from the active state to the idle state. The is an idle state entry. Subsequently, when VID transitions from requesting an output of 0 V to requesting an output of Vnominal at t3, this means there is a transition from the idle state to the active state. This is an idle state exit.

The waveform 710 depicts the Cap_isolate signal, which can be the signal on the path 475 in FIGS. 4 and 5. The inverse of this signal can be used on the path 475 in FIG. 6. When the SoC is active, Cap_isolate is high, and the isolation of the capacitors C1-C3 in FIGS. 4 and 5 is off, e.g., they are not isolated. When the SoC transitions to the inactive state at t1, Cap_isolate goes low so that the isolation of the capacitors C1-C3 in FIGS. 4 and 5 is on, e.g., they are isolated. When the SoC transitions from idle to active at t3, there is a delay of Δt1, until t4, before Cap isolate goes to the off level due to the time needed for the Voutput to ramp up to a desired target level, e.g., Vnominal. If the isolation was turned off too soon, before Voutput=Vnominal, this could result in a sudden change in Voutput. When the switches turn on, the bulk capacitors are biased by the voltage, Voutput, on the voltage power rail.

The waveforms 720 and 730 represent the High_FET line and Low_FET line, respectively, which may be the paths 441 and 442, respectively, in FIG. 4-6. The High_FET line is high when the Low_FET line is low, and the High_FET line is low when the Low_FET line is high. A switching cycle period, as depicted by the arrow 731, extends from t0 to t2, and comprises one pulse 721 of the High_FET line followed by one pulse 732 of the Low_FET line. In this example, the SoC transitions from active to inactive at a time t1 which is partway through the switching cycle. The VR controller completes the switching cycle before it stops switching the VR at t2. Once the VR switching stops, Voutput (waveform 750) begins to decay from an initial level referred to as Vout_target (Vnominal). When Voutput decays by an amount ΔV below Vout_target, the VR controller sets power good (also referred to as alert #) to a low or off level, indicating Voutput is not suitable for use by the SoC in an active mode. In other words, when Voutput falls below a threshold, Vthreshold, e.g., Vtarget-Δ, the VR controller sets power good to off.

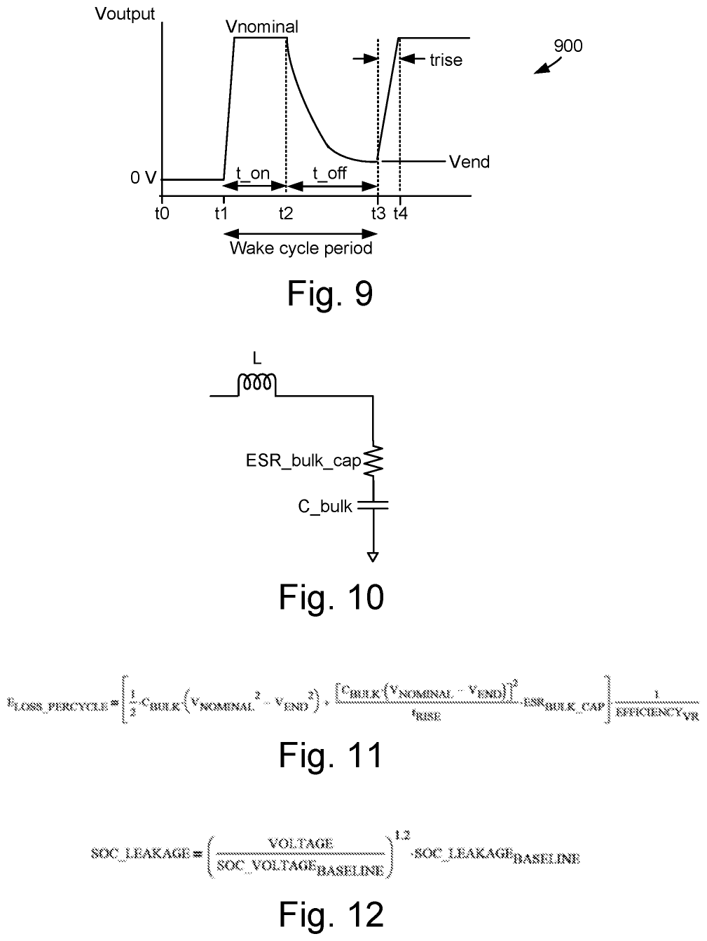

When the SoC transitions from idle to active, the VR controller begins switching the VR to increase Voutput back to a target voltage. Voutput may have decayed to 0 V if the time at the idle state was sufficiently long, or to a positive voltage if the time at the idle state was relatively short (see also FIG. 9). When Voutput exceeds a threshold such as Vtarget-Δ, the Cap_isolate signal can be set high, indicating the bulk capacitors are no longer isolated and can serve their role in stabilizing Voutput. The value of Δ in the active-to-idle transition can be the same as, or different than, the value in the idle-to-active transition. As Voutput approaches Vnominal, which should be close to Vcc_bulk, the switches turn on, so that the bulk capacitors are biased by the voltage, Voutput, on the voltage power rail. In one approach, the turn on should occur when Voutput=Vcc_bulk to minimize charge redistribution and to ensure switching losses are minimized.

The ramp up time for Voutput is Δt1 in this example. The VR controller can end the capacitor isolation when Voutput is first detected as being greater than Vtarget-Δ, in one approach. In another possible approach, the VR requires Voutput>Vtarget-Δ for a minimum period of time before ending the capacitor isolation. After the capacitor isolation is ended, the VR can assert power good high to inform the SoC that Voutput is within specifications such that it is safe for the SoC to begin operations. In one approach, the VR controller delays the assertion of power good by a time period Δt2, until t5, after Cap_isolate is asserted, to ensure Voutput is stable.

Waveform 740 represents Vcc_bulk, the voltage across the bulk transistors C1-C3. Advantageously, Vcc_bulk remains at a substantially fixed level such as Vout_target throughout the transitions between the active and idle states.

An example SoC idle entry sequence includes:
1.) 0 V VID enter command received by VR controller.
2.) VR controller pulls isolation line low immediately, disconnecting the bulk capacitors from Voutput.
3.) VR stops switching and Voutput is left to decay by the SoC leakage current.
4.) Powergood/Alert #gets de-asserted as voltage decays.

An example SoC idle exit sequence includes:
1.) 0 V VID exit command received by VR controller.
2.) VR controller starts switching.
3.) Voutput ramps up.

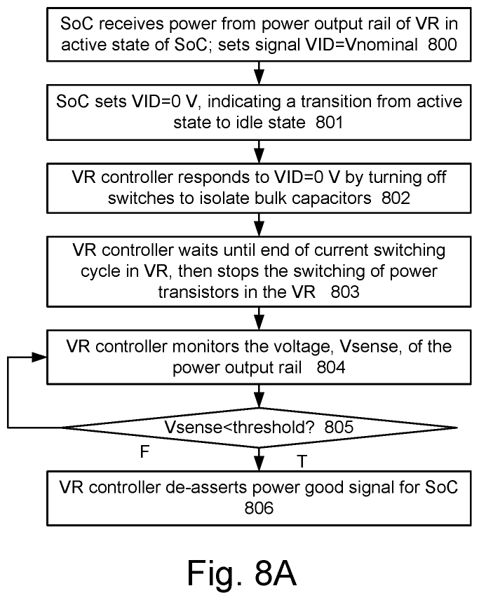

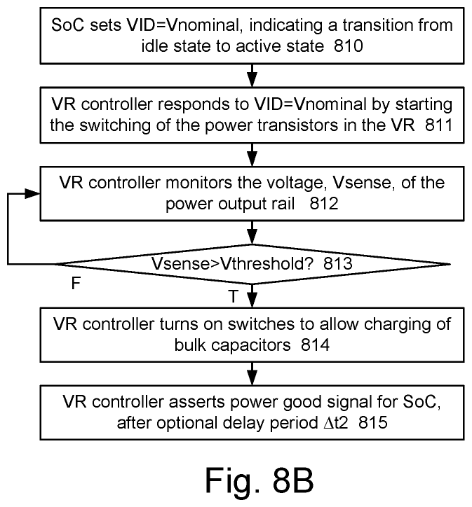

FIG. 8A depicts a flowchart of an example process in which a SoC transitions from an active state to an idle state, according to various embodiments. At block 800, the SoC receives power from power output rail of the VR in the active state of SoC, and sets signal VID=Vnominal. At block 801, the SoC sets VID=0 V, indicating a transition from the active state to the idle state. At block 802, the VR controller responds to VID-0 V by turning off switches to isolate the bulk capacitors. At block 803, the VR controller waits until the end of the present switching cycle (the current, ongoing switching cycle) in the VR, then stops the switching of the power transistors in the VR. At block 804, the VR controller monitors the voltage, Vsense, of the power output rail.

A decision block 805 determines whether Vsense<Vthreshold. If the decision block is false (F), block 804 is repeated. If the decision block is true (T), block 806 is reached in which the VR controller de-asserts the power good signal for the SoC, e.g., sets power good=off.

FIG. 8B depicts a flowchart of an example process in which a SoC transitions from an idle state to an active state, according to various embodiments. At block 810, the SoC sets VID=Vnominal, indicating a transition from the idle state to the active state. At block 811, the VR controller responds to VID=Vnominal by starting the switching of the power transistors in the VR. At block 812, the VR controller monitors the voltage, Vsense, of the power output rail. A decision block 813 determines whether Vsense>Vthreshold. If the decision block is false (F), block 812 is repeated. If the decision block is true (T), block 814 is reached in which the VR controller turns on the switches to allow charging of the bulk capacitors. At block 815, the VR controller asserts the power good signal for the SoC, e.g., sets power good=on, after an optional delay period Δt2.

FIG. 9 depicts an example plot 900 of a voltage output of a VR versus time, in a discussion of energy savings per wake cycle period, according to various embodiments. As mentioned in connection with FIG. 1B, Voutput ramps up when the SoC transitions from the idle to the active state, e.g., starting at t1. From t1 to t2, a period referred to as t_on, the VR is on. That is, the VR is operating and outputting a voltage. At t2, the SoC transitions from the active to the idle state. From t2 to t3, a period referred to as t_off, the VR is off so that the output voltage decays. In this example, t_off is relatively short so that the output is at a positive voltage, Vend, when the SoC transitions back to the active state at t3. The ramp up time is trise, and extends from t3 to t4. A wake cycle period can be defined as the time from t1 to t3, e.g., the time between consecutive idle-to-active transitions.

FIG. 10 depicts an example circuit in a VR including an inductor L, an equivalent series resistance (ESR_bulk_cap) of a bulk capacitor, and a capacitance (C_bulk) of the bulk capacitance, in a discussion of energy savings per wake cycle period, according to various embodiments. This circuit separates out the resistance and capacitance components of a bulk capacitor.

FIG. 11 depicts an example energy consumption equation for a wake cycle period such as depicted in FIG. 9, according to various embodiments. As mentioned, the repeated decay and charging of the bulk capacitors of a VR results in significant energy consumption. The solutions provided herein avoid this problem and therefore achieve a significant reduction in energy consumption. E_{LOSS_PERCYCLE} is the energy loss per wake cycle. C_{BULK} is the capacitance of a bulk capacitor, as in FIG. 10. V_{NOMINAL} is the typical requested output voltage of the VR in the active state of the SoC. V_{END} in the minimum voltage to which Voutput decays in the idle state, as in FIG. 9. t_{RISE} is the rise time, as in FIG. 9. ESR_{BULK_CAP} is the equivalent series resistance as in FIG. 10. EFFICIENCY_{VR} is the efficiency of the voltage regulator, e.g., 80-90%.

FIG. 12 depicts an example SoC leakage current model, according to various embodiments. The model assumes a constant temperature baseline, and is based on bin split data for an example processor and equations governing temperature and voltage. This SoC leakage model is used to determine Vend for a given t_off. For a given constant temperature, the SoC leakage current is modeled using the equation shown.

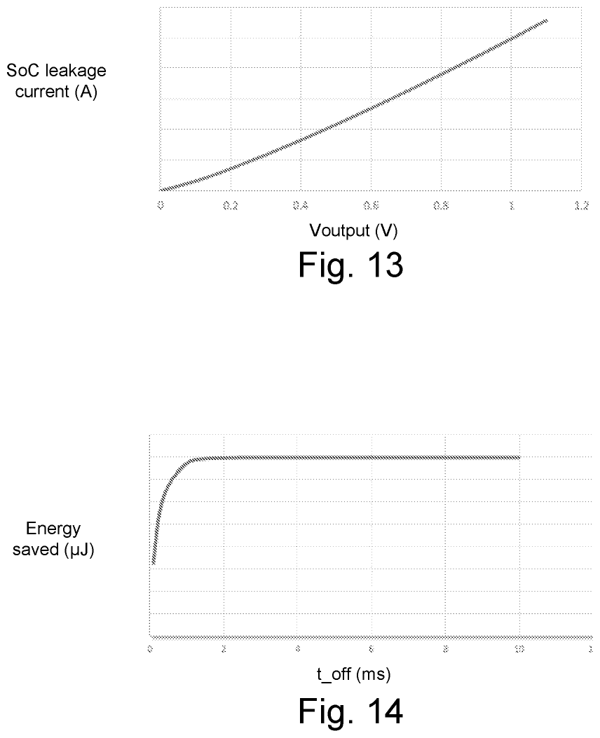

FIG. 13 depicts an example plot of SoC leakage current versus Voutput, according to various embodiments. The leakage current increases roughly linearly with an increase in Voutput.

FIG. 14 depicts an example plot of energy saved in a wake cycle period as a function of t_off (a VR off time), according to various embodiments. Using the SoC leakage model equation of FIG. 12 in a simulation and a nominal 1.1 V capacitance, Vend is determined based on the length of t_off. The data is then used for energy calculation using the equation in FIG. 11 to obtain the graph shown. The energy saved increases rapidly and then plateaus at a maximum level with t_off of 1 ms. or greater.

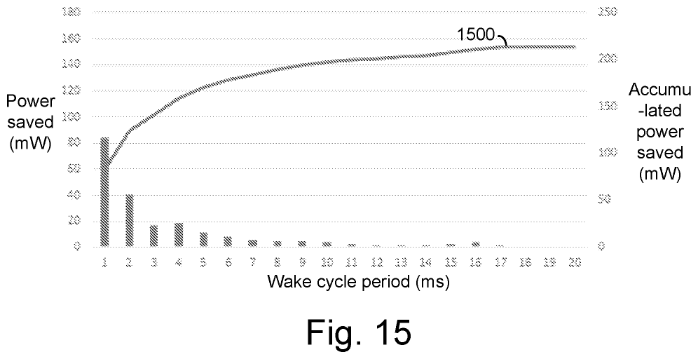

FIG. 15 depicts an example bar chart of power saved as a function of wake cycle period and a plot 1500 of accumulated power saved as a function of wake cycle period, according to various embodiments. By combining the data of energy saved in one wake cycle period from FIG. 14 and the real-world wake time distribution of FIG. 3, the real-world power savings can be calculated. As expected, the power saved is greater when the wake cycle is shorter.

The same charge isolation architecture as described herein for capacitors in a VR can also be applied to voltage rails that frequently go into an idle mode. VccGT and VccSA are examples. VccGT is a Processor Graphics Supply DC Voltage. VccSA is a system agent voltage for a Peripheral Component Interconnect (PCI) Express controller, memory controller, and display engine. By expanding the use of the charge isolation architecture, additional system level power savings can be achieved.

In addition to power savings, latency can be reduced when the SoC transitions from the idle state to the active state. During the transition, the inrush current to charge the capacitor depends on the slew rate and the amount of capacitance needed to charge. With the charge isolation architecture, the VR sees a lower amount of capacitance and therefore can ramp up faster to the desired voltage with a lower inrush current. The architecture is expected to improve latency by two to three times compared to a traditional architecture.

In sum, the architecture improves efficiency in every SoC idle exit. The charge in the bulk capacitors can be retained and reused in the subsequent SoC idle exit, rather than being dissipated by SoC leakage current during the idle state. Other benefits can be achieved as well, including reduced latency due to a faster slew rate without any negative inrush current side effect. Moreover, acoustic noise, which affects ceramic capacitors, for instance, can also be greatly reduced as the ceramic capacitors no longer see any droop in voltage when the SoC enters and exits the idle state.

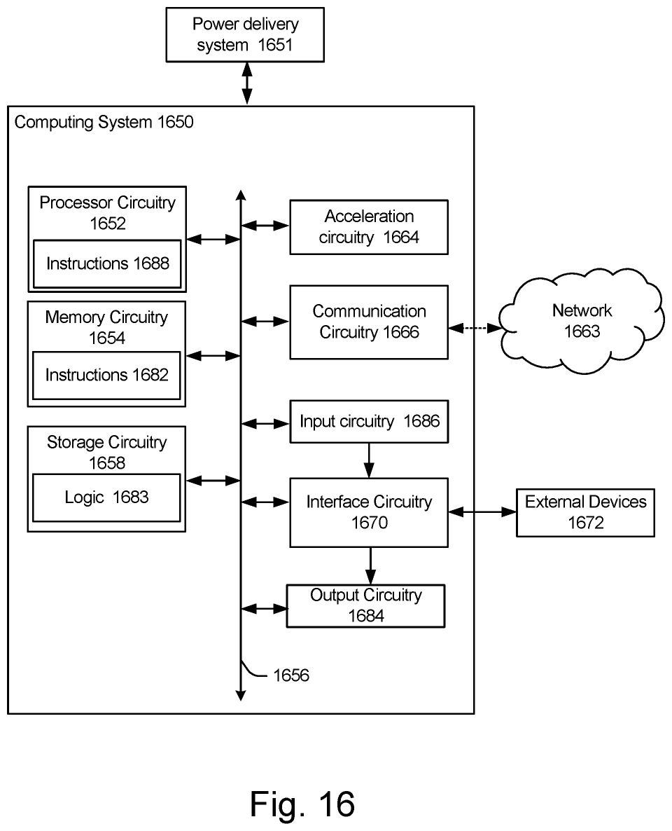

FIG. 16 illustrates an example of components that may be present in a computing system 1650 for implementing the techniques (e.g., operations, processes, methods, and methodologies) described herein. The power delivery system 1651 may represent any of the circuits 400, 500 and 600 in FIG. 4, 5 or 6, respectively. The computing system 1650 or processor circuitry 1652 may represent the SoC 101.

The computing system 1650 may include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 1650, or as components otherwise incorporated within a chassis of a larger system. For one embodiment, at least one processor 1652 may be packaged together with computational logic 1682 and configured to practice aspects of various example embodiments described herein to form a System in Package (SiP) or a System on Chip (SoC).

The system 1650 includes processor circuitry in the form of one or more processors 1652. The processor circuitry 1652 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 1652 may include one or more hardware accelerators (e.g., same or similar to acceleration circuitry 1664), which may be microprocessors, programmable processing devices (e.g., FPGA, ASIC, etc.), or the like. The one or more accelerators may include, for example, computer vision and/or deep learning accelerators. In some implementations, the processor circuitry 1652 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein

The processor circuitry 1652 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low voltage processor, an embedded processor, or any other known processing elements, or any suitable combination thereof. The processors (or cores) 1652 may be coupled with or may include memory/storage and may be configured to execute instructions stored in the memory/storage to enable various applications or operating systems to run on the platform 1650. The processors (or cores) 1652 is configured to operate application software to provide a specific service to a user of the platform 1650. In some embodiments, the processor(s) 1652 may be a special-purpose processor(s)/controller(s) configured (or configurable) to operate according to the various embodiments herein.

As examples, the processor(s) 1652 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 1652 may be a part of a system on a chip (SoC), System-in-Package (SiP), a multi-chip package (MCP), and/or the like, in which the processor(s) 1652 and other components are formed into a single integrated circuit, or a single package, such as the Edison™ or Galileo™ SoC boards from Intel® Corporation. Other examples of the processor(s) 1652 are mentioned elsewhere in the present disclosure.

The system 1650 may include or be coupled to acceleration circuitry 1664, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 1664 may comprise logic blocks or logic fabric and other interconnected resources that may be programmed (configured) to perform various functions, such as the procedures, methods, functions, etc. of the various embodiments discussed herein. In such implementations, the acceleration circuitry 1664 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 1652 and/or acceleration circuitry 1664 may include hardware elements specifically tailored for machine learning and/or artificial intelligence (AI) functionality. In these implementations, the processor circuitry 1652 and/or acceleration circuitry 1664 may be, or may include, an AI engine chip that can run many different kinds of AI instruction sets once loaded with the appropriate weightings and training code. Additionally or alternatively, the processor circuitry 1652 and/or acceleration circuitry 1664 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPS™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 1652 and/or acceleration circuitry 1664 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin 970 provided by Huawei®, and/or the like. In some hardware-based implementations, individual subsystems of system 1650 may be operated by the respective AI accelerating co-processor(s), AI GPUs, TPUs, or hardware accelerators (e.g., FPGAS, ASICs, DSPs, SoCs, etc.), etc., that are configured with appropriate logic blocks, bit stream(s), etc. to perform their respective functions.

The system 1650 also includes system memory 1654. Any number of memory devices may be used to provide for a given amount of system memory. As examples, the memory 1654 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 1654 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 1654 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 1658 provides persistent storage of information such as data, applications, operating systems and so forth. In an example, the storage 1658 may be implemented via a solid-state disk drive (SSDD) and/or high-speed electrically erasable memory (commonly referred to as “flash memory”). Other devices that may be used for the storage 1658 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 1654 and/or storage circuitry 1658 may also incorporate three-dimensional (3D) cross-point (XPOINT) memories from Intel® and Micron®.

The memory circuitry 1654 and/or storage circuitry 1658 is/are configured to store computational logic 1683 in the form of software, firmware, microcode, or hardware-level instructions to implement the techniques described herein. The computational logic 1683 may be employed to store working copies and/or permanent copies of programming instructions, or data to create the programming instructions, for the operation of various components of system 1650 (e.g., drivers, libraries, application programming interfaces (APIs), etc.), an operating system of system 1650, one or more applications, and/or for carrying out the embodiments discussed herein. The computational logic 1683 may be stored or loaded into memory circuitry 1654 as instructions 1682, or data to create the instructions 1682, which are then accessed for execution by the processor circuitry 1652 to carry out the functions described herein. The processor circuitry 1652 and/or the acceleration circuitry 1664 accesses the memory circuitry 1654 and/or the storage circuitry 1658 over the interconnect (IX) 1656. The instructions 1682 direct the processor circuitry 1652 to perform a specific sequence or flow of actions, for example, as described with respect to flowchart(s) and block diagram(s) of operations and functionality depicted previously. The various elements may be implemented by assembler instructions supported by processor circuitry 1652 or high-level languages that may be compiled into instructions 1688, or data to create the instructions 1688, to be executed by the processor circuitry 1652. The permanent copy of the programming instructions may be placed into persistent storage devices of storage circuitry 1658 in the factory or in the field through, for example, a distribution medium (not shown), through a communication interface (e.g., from a distribution server (not shown)), over-the-air (OTA), or any combination thereof.

The IX 1656 couples the processor 1652 to communication circuitry 1666 for communications with other devices, such as a remote server (not shown) and the like. The communication circuitry 1666 is a hardware element, or collection of hardware elements, used to communicate over one or more networks 1663 and/or with other devices. In one example, communication circuitry 1666 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 1666 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 1656 also couples the processor 1652 to interface circuitry 1670 that is used to connect system 1650 with one or more external devices 1672. The external devices 1672 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 1650, which are referred to as input circuitry 1686 and output circuitry 1684. The input circuitry 1686 and output circuitry 1684 include one or more user interfaces designed to enable user interaction with the platform 1650 and/or peripheral component interfaces designed to enable peripheral component interaction with the platform 1650. Input circuitry 1686 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 1684 may be included to show information or otherwise convey information, such as sensor readings, actuator position(s), or other like information. Data and/or graphics may be displayed on one or more user interface components of the output circuitry 1684. Output circuitry 1684 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 1650. The output circuitry 1684 may also include speakers and/or other audio emitting devices, printer(s), and/or the like. Additionally or alternatively, sensor(s) may be used as the input circuitry 1684 (e.g., an image capture device, motion capture device, or the like) and one or more actuators may be used as the output device circuitry 1684 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 1650 may communicate over the IX 1656. The IX 1656 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 1656 may be a proprietary bus, for example, used in a SoC based system.

The number, capability, and/or capacity of the elements of system 1650 may vary, depending on whether computing system 1650 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 1650 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible machine readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

Some non-limiting examples of various embodiments are presented below.

Example 1 includes an apparatus, comprising: a voltage regulator comprising a power output rail and a path coupled to the power output rail and ground, wherein the path comprises a switch and a capacitor; and a controller of the voltage regulator, wherein the controller is to receive a signal from a circuit which indicates whether the circuit is in an active state or an idle state, the power output rail is to provide power to the circuit, and the controller is to turn off the switch when the signal indicates the circuit transitions from the active state to the idle state.

Example 2 includes the apparatus of Example 1, wherein: when the switch is turned on, a voltage of one side of the capacitor is at ground; and when the switch is turned off, the voltage of the one side of the capacitor is floated.

Example 3 includes the apparatus of Example 1 or 2, wherein: the capacitor is one of a plurality of capacitors; and each capacitor of the plurality of capacitors is coupled to the power output rail and ground via a respective path and each respective path comprises a respective switch.

Example 4 includes the apparatus of any one of Examples 1-3, further comprising one or more decoupling capacitors coupled to the power output rail.

Example 5 includes the apparatus of any one of Examples 1-4, wherein: the voltage regulator is a switching voltage regulator; and when the signal indicates the circuit transitions from the idle state to the active state, the controller is to start to switch the voltage regulator to increase a voltage of the power output rail, and the controller is to turn on the switch when the controller senses that a voltage of the power output rail has increased above a threshold.

Example 6 includes the apparatus of any one of Examples 1-5, wherein the controller is to assert a power good signal to the circuit which indicates the power output rail is ready for use by the circuit, and the power good signal is delayed until after the controller turns on the switch.

Example 7 includes the apparatus of any one of Examples 1-6, wherein when the signal indicates the circuit transitions from the active state to the idle state, the controller is to turn off the switch during a present switching cycle.

Example 8 includes the apparatus of Example 7, wherein when the signal indicates the circuit transitions from the active state to the idle state, the controller is to complete the present switching cycle before it is to stop switching the voltage regulator.

Example 9 includes the apparatus of any one of Examples 1-8, wherein the switch comprises an n-type transistor between the capacitor and ground.

Example 10 includes the apparatus of any one of Examples 1-8, wherein the switch comprises a p-type transistor between the capacitor and the power output rail.

Example 11 includes the apparatus of any one of Examples 1-10, wherein: the signal comprises a voltage identification signal which identifies a requested voltage output of the voltage regulator.

Example 12 includes an apparatus, comprising: a memory to store instructions; and a processor coupled to the memory, wherein the processor is to receive power from a voltage rail of a voltage regulator, the voltage regulator comprises a power output rail and a path coupled to the power output rail and ground, the path comprises a switch and a capacitor, the processor is to execute the instructions to provide a signal to a controller of the voltage regulator which indicates whether the processor is in an active state or an idle state, and the controller is responsive to the signal to control the switch according to whether the signal indicates the processor is in the active state or the idle state.

Example 13 includes the apparatus of Example 12, wherein the processor is to execute the instructions to wait to receive a power good signal from the controller which indicates the switch has transitioned from being turned off to being turned on, before the processor resumes operations in the active state.

Example 14 includes the apparatus of Example 13, wherein the processor is to receive the power good signal after a delay period has passed since the switch has transitioned from being turned off to being turned on.

Example 15 includes an apparatus, comprising: a memory to store instructions; and a microcontroller coupled to the memory, wherein the microcontroller is to receive a signal from a system on a chip (SoC) which indicates whether the SoC is in an active state or an idle state, and the microcontroller is to stop switching of a voltage regulator and prevent discharge of a capacitor coupled to a power output rail of the voltage regulator when the signal indicates the SoC has transitioned from the active state to the idle state.

Example 16 includes the apparatus of Example 15, wherein when the signal indicates the SoC transitions from the active state to the idle state, the microcontroller is to wait until the voltage regulator completes a present switching cycle before the microcontroller stops the switching of the voltage regulator.

Example 17 includes the apparatus of Example 16, wherein when the signal indicates the SoC transitions from the active state to the idle state, the microcontroller is to prevent the discharge of the capacitor during the present switching cycle, before the stopping of the switching of the voltage regulator.

Example 18 includes the apparatus of any one of Examples 15-17, wherein when the signal indicates the SoC transitions from the idle state to the active state, the microcontroller is to start switching of the voltage regulator, monitor a voltage of the power output rail and allow charging of the capacitor from the power output rail when the monitored voltage exceeds a threshold.

Example 19 includes the apparatus of any one of Examples 15-18, wherein: the voltage regulator comprises a power output rail; the capacitor is coupled to the power output rail and ground in a path; the path comprises a switch; and to prevent the discharge of the capacitor, the microcontroller is to turn off the switch.

Example 20 includes the apparatus of Example 19, wherein: when the microcontroller is to turn on the switch, the capacitor is to be charged by the power output rail; and when the microcontroller is to turn off the switch, the capacitor is to be isolated from charging from the power output rail.

Example 21 includes the apparatus of Example 19, wherein: when the microcontroller is to turn on the switch, a voltage of one side of the capacitor is at ground; and when the microcontroller is to turn off the switch, the voltage of the one side of the capacitor is floated.

In the present detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus, comprising:
a voltage regulator comprising a power output rail and a path, wherein the path is coupled to the power output rail and ground, and wherein the path comprises a switch and a capacitor; and
a controller of the voltage regulator, wherein the controller is to receive a signal from a circuit which indicates whether the circuit is in an active state or an idle state, the power output rail is to provide power to the circuit, and the controller is to turn off the switch when the signal indicates the circuit transitions from the active state to the idle state.

2. The apparatus of claim 1, wherein:
when the switch is turned on, a voltage of one side of the capacitor is at ground; and
when the switch is turned off, the voltage of the one side of the capacitor is floated.

3. The apparatus of claim 1, wherein:
the capacitor is one of a plurality of capacitors; and
each capacitor of the plurality of capacitors is coupled to the power output rail and ground via a respective path and each respective path comprises a respective switch.

4. The apparatus of claim 1, further comprising one or more decoupling capacitors coupled to the power output rail.

5. The apparatus of claim 1, wherein:
the voltage regulator is a switching voltage regulator; and
when the signal indicates the circuit transitions from the idle state to the active state, the controller is to start to switch the voltage regulator to increase a voltage of the power output rail, and the controller is to turn on the switch when the controller senses that a voltage of the power output rail has increased above a threshold.

6. The apparatus of claim 1, wherein the controller is to assert a power good signal to the circuit which indicates the power output rail is ready for use by the circuit, and the power good signal is delayed until after the controller turns on the switch.

7. The apparatus of claim 1, wherein when the signal indicates the circuit transitions from the active state to the idle state, the controller is to turn off the switch during a present switching cycle.

8. The apparatus of claim 7, wherein when the signal indicates the circuit transitions from the active state to the idle state, the controller is to complete the present switching cycle before it is to stop switching the voltage regulator.

9. The apparatus of claim 1, wherein the switch comprises an n-type transistor between the capacitor and ground.

10. The apparatus of claim 1, wherein the switch comprises a p-type transistor between the capacitor and the power output rail.

11. The apparatus of claim 1, wherein:
the signal comprises a voltage identification signal which identifies a requested voltage output of the voltage regulator.

12. An apparatus, comprising:
a memory to store instructions; and
a processor coupled to the memory, wherein the processor is to receive power from a voltage rail of a voltage regulator, the voltage regulator comprises a power output rail and a path, the path is coupled to the power output rail and ground, the path comprises a switch and a capacitor, the processor is to execute the instructions to provide a signal to a controller of the voltage regulator which indicates whether the processor is in an active state or an idle state, and the controller is responsive to the signal to control the switch according to whether the signal indicates the processor is in the active state or the idle state.

13. The apparatus of claim 12, wherein the processor is to execute the instructions to wait to receive a power good signal from the controller which indicates the switch has transitioned from being turned off to being turned on, before the processor resumes operations in the active state.

14. The apparatus of claim 13, wherein the processor is to receive the power good signal after a delay period has passed since the switch has transitioned from being off to being on.

15. An apparatus, comprising:
a memory to store instructions; and
a microcontroller coupled to the memory, wherein the microcontroller is to receive a signal from a system on a chip (SoC) which indicates whether the SoC is in an active state or an idle state, and the microcontroller is to stop switching of a voltage regulator and prevent discharge of a capacitor coupled to a power output rail of the voltage regulator when the signal indicates the SoC has transitioned from the active state to the idle state.

16. The apparatus of claim 15, wherein when the signal indicates the SoC transitions from the active state to the idle state, the microcontroller is to wait until the voltage regulator completes a present switching cycle before the microcontroller stops the switching of the voltage regulator.

17. The apparatus of claim 16, wherein when the signal indicates the SoC transitions from the active state to the idle state, the microcontroller is to prevent the discharge of the capacitor during the present switching cycle, before the stopping of the switching of the voltage regulator.

18. The apparatus of claim 15, wherein when the signal indicates the SoC transitions from the idle state to the active state, the microcontroller is to start switching of the voltage regulator, monitor a voltage of the power output rail and allow charging of the capacitor from the power output rail when the monitored voltage exceeds a threshold.

19. The apparatus of claim 15, wherein:
the voltage regulator comprises a power output rail;
the capacitor is coupled to the power output rail and ground in a path;
the path comprises a switch; and
to prevent the discharge of the capacitor, the microcontroller is to turn off the switch.

20. The apparatus of claim 19, wherein:
when the microcontroller is to turn on the switch, the capacitor is to be charged by the power output rail; and
when the microcontroller is to turn off the switch, the capacitor is to be isolated from charging from the power output rail.

21. The apparatus of claim 19, wherein:
when the microcontroller is to turn on the switch, a voltage of one side of the capacitor is at ground; and
when the microcontroller is to turn off the switch, the voltage of the one side of the capacitor is floated.
